(19) United States
(12) Patent Application Publication
(10) Pub. No.: US 2007/0223852 A1
(43) Pub. Date: Sep. 27, 2007

(54) Ceramic bearing

(76) Inventor: Yu Hao Lee, Taichung City (TW)

Correspondence Address: BANGER SHIA, 204 CANYON CREEK, VICTORIA, TX, 77901-3695, US

(21) Appl. No.: 11/386,904

(22) Filed: Mar. 21, 2006

(51) Int. Cl. F16C 33/20

(52) U.S. Cl. 384/297

(57) ABSTRACT

A ceramic bearing includes a first ring, a second ring and two skates all of which are made of ceramics. The second ring is positioned in the first ring. The skates are provided between the first and second rings so that the first and second rings can be rotated relative to each other smoothly and quietly.

### BACKGROUND OF INVENTION

1. Field of Invention

The present invention relates to a ceramic bearing including a first ring and a second ring contacting the first ring in reduced areas so that they can be rotated to each other smoothly and silently, thus increasing the economic effects thereof.

2. Related Prior Art

A bearing is often provided between two objects that are rotational relative to each other so that the relative rotation between the objects is smooth and stable. Thus, the objects will not wear away each other. Hence, a bearing is an important element in a rotational mechanism. According to the rotational directions, bearings can be classified into axial bearings and radial bearings. According to the shapes, bearings can be classified into ball bearings and roller bearings.

Bearings are conventionally made of metal. Metal bearings are complicated in structure and cannot easily be assembled. Metal bearings cannot be installed in delicate occasions for being bulky. Metal bearings cannot be used in electrical devices for being poor in thermal radiation.

To solve the problems encountered by metal bearings, there have been developed ceramic bearings since ceramics is strong, wear-proof, rigid, erosion-proof, heat-proof, highly thermally radiant and electrically and magnetically insulating. For these natures that are impossible with metal, ceramic bearings are getting more and more popular, particularly in aero-space industry, electrical industry and foodstuff industry. It requires higher costs of material and higher techniques to produce ceramic bearings than metal bearings. There have been attempts to reduce the costs and simplify the structures of ceramic bearings. Examples can be found in Taiwanese Patent Publication Nos. 524286 and 524287. A ceramic bearing is small and cannot easily be processed so that it is difficult to provide balls or rollers between a first ring and a second ring. The second ring is in direct contact with the first ring. To avoid unstable rotation and rattling, it is required that the entire internal side of the first ring contacts the entire external side of the second ring. To this end, the internal diameter of the first ring and the external diameter of the second ring must be very close to each other. However, because of such a large area of contact, the operation of the ceramic bearing bends to be unsmooth and noisy.

The present invention is therefore intended to obviate or at least alleviate the problems encountered in prior art.

### SUMMARY OF INVENTION

It is an objective of the present invention to provide a ceramic bearing that is operable smoothly and quietly.

According to the present invention, a ceramic bearing includes a first ring, a second ring and two skates. The second ring is positioned in the first ring. The skates are provided between the first and second rings so that the first and second rings can be rotated relative to each other smoothly and quietly.

Other objectives, advantages and features of the present invention will become apparent from the following description referring to the attached drawings.

### BRIEF DESCRIPTION OF DRAWINGS

The present invention will be described through detailed illustration of four embodiments referring to the drawings.

FIG. 1 is an exploded view of a ceramic bearing according to the first embodiment of the present invention.

FIG. 2 is a perspective view of the ceramic bearing shown in FIG. 1.

FIG. 3 is a cross-sectional view of the ceramic bearing of FIG. 2.

FIG. 4 is a cross-sectional view of a ceramic bearing according to the second embodiment of the present invention.

FIG. 5 is a cross-sectional view of a ceramic bearing according to the third embodiment of the present invention.

FIG. 6 is a cross-sectional view of a ceramic bearing according to the fourth embodiment of the present invention.

### DETAILED DESCRIPTION OF EMBODIMENTS

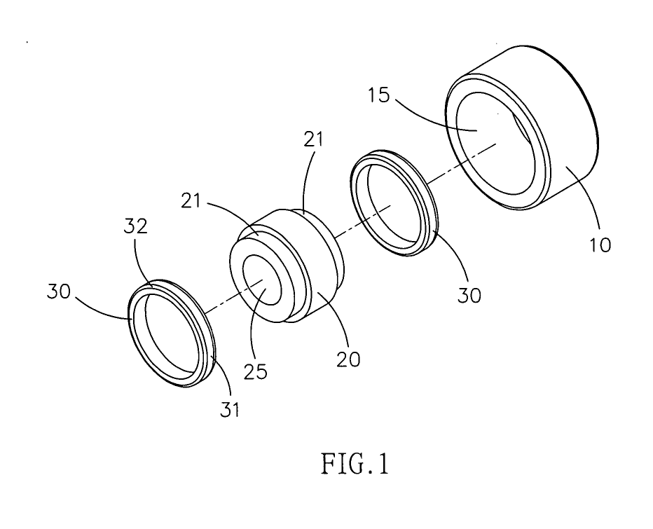

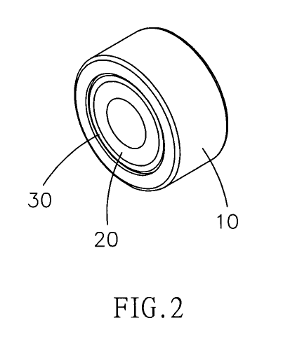

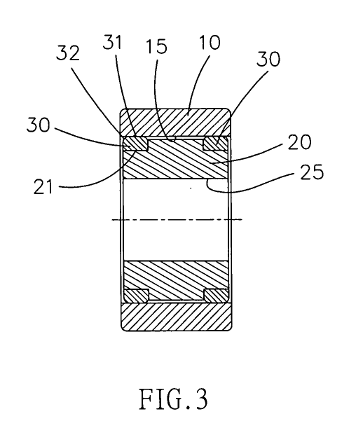

Referring to FIGS. 1 through 3, there is shown a ceramic bearing according to a first embodiment of the present invention. The ceramic bearing includes a first ring 10, a second ring 20 positioned in the first ring 10 and two skates 30 positioned between the second ring 20 and the first ring 10. The first ring 10, the second ring 20 and the skates 30 are all made of ceramics.

The first ring 10 can be used as a stator while the second ring 20 can be used as a rotor. Alternatively, the first ring 10 can be used as a rotor while the second ring 20 can be used as a stator. The skates 30 can be attached to the stator or the rotor so that they become part of the stator or the rotor.

The first ring 10 includes a cylindrical or polyhedral external profile. The first ring 10 defines an axial bore 15. The axial bore 15 is circular when viewed in an axial direction.

The second ring 20 includes a cylindrical external profile so that it can be positioned in the axial bore 15 of the first ring 10. The second ring 20 defines an axial bore 25. The axial bore 25 is circular or polygonal when viewed in an axial direction. The second ring 20 includes two reduced necks 21.

Each of the skates 30 includes two opposite chamfers 32 on an external side and a flat ridge 31 between the chamfers 32. The skates 30 are fit on the necks 21 of the second ring 20. Thus, the skates 30 and the second ring 20 become one.

The total area of contact between the stator and rotor is small so that the operation of the ceramic bearing is smooth and quiet. The friction between the stator and rotor is reduced and they will not easily wear away each other.

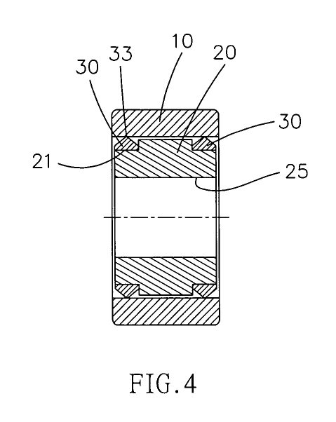

Referring to FIG. 4, there is shown a ceramic bearing according to a second embodiment of the present invention. The second embodiment is like the first embodiment except that each of the skates 30 includes a sharp ridge 33 instead of the flat ridge 31 between the chamfers 32.

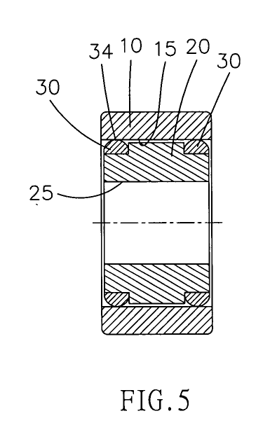

Referring to FIG. 5, there is shown a ceramic bearing according to a third embodiment of the present invention. The third embodiment is like the second embodiment except that each of the skates 30 includes a rounded ridge instead of the sharp ridge 33.

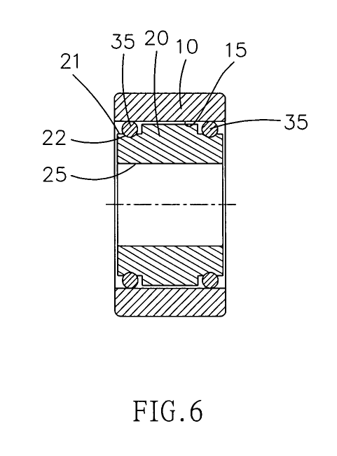

Referring to FIG. 6, there is shown a ceramic bearing according to a fourth embodiment of the present invention. The fourth embodiment is like the first embodiment except including two skates 35 instead of the skates 30. The skates 35 include a circular cross-sectional configuration. Each of the skates 35 is partially positioned in a groove 22 defined in related one of the necks 21 of the second ring 20.

In another embodiment, the skates 30 may be fit in the first ring 10 so that the first ring 10 and the skates 30 become one. In such a case, each of the skates 30 includes a ridge on an internal side for skating on the external side of the second ring 20.

The present invention has been described through the illustration of the embodiments. Those skilled in the art can derive variations from the embodiments without departing from the scope of the present invention. Therefore, the embodiments shall not limit the scope of the present invention defined in the claims.

1. A ceramic bearing comprising a first ring, a second ring positioned in the first ring and two skates provided between the first and second rings so that the first and second rings can be rotated relative to each other smoothly and quietly.

2. The ceramic bearing according to claim 1 wherein the second ring comprises two necks on which the skaters are installed.

3. The ceramic bearing according to claim 1 wherein the skates are fit on the second ring.

4. The ceramic bearing according to claim 3 wherein each of the skates comprises two chamfers on an external side and a flat ridge between the chamfers.

5. The ceramic bearing according to claim 3 wherein each of the skates comprises a sharp ridge for contact with the first ring.

6. The ceramic bearing according to claim 3 wherein each of the skates comprises a rounded ridge for contact with the first ring.

7. The ceramic bearing according to claim 3 wherein the skates comprise a circular cross-sectional configuration.

8. The ceramic bearing according to claim 1 wherein the second ring comprises two grooves for receiving the skates.

9. The ceramic bearing according to claim 1 wherein the skates are fit in the first ring.
